(19) United States
(12) Patent Application Publication
(10) Pub. No.: US 2013/0039829 A1
(43) Pub. Date: Feb. 14, 2013

(54) ACID GAS RECOVERY UTILIZING ORGANIC ACID SALTED DIAMINE

(71) Applicant: Michel Ouimet, Montreal (CA)

(72) Inventor: Michel Ouimet, Montreal (CA)

(73) Assignee: CANSOLV TECHNOLOGIES INC., Montreal (CA)

(21) Appl. No.: 13/205,982

(22) Filed: Aug. 9, 2011

(51) Int. Cl. B01D 53/50

(52) U.S. Cl. 423/242.6; 423/242.7

(57) ABSTRACT

A process for the capture of sulfur dioxide from a gaseous stream utilizing a regenerable diamine absorbent comprising a diamine and a weak organic acid.

### FIELD

This invention relates to an improved process of the capture of sulfur dioxide (SO₂) from gaseous streams using an absorbent.

### INTRODUCTION

Processes which utilize a regenerable absorbent to remove sulfur dioxide from gas streams are known. Typically, the absorbent is exposed to a sulfur dioxide containing gas stream whereby sulfur dioxide is absorbed by the absorbent producing a SO₂ lean gas stream and a spent absorbent stream. The spent absorbent stream contains amine/sulfur dioxide salts. The absorbent is regenerated by steam stripping. Under elevated temperatures, the amine/sulfur dioxide salts decompose resulting in a regenerated lean sulfur dioxide absorbent and sulfur dioxide gas. See for example Ravary et al. (U.S. Pat. No. 7,214,358).

Salts which cannot be regenerated by steam stripping may be formed. These salts, which are referred to as “heat stable salts” or “HSS”, are too stable to decompose under steam stripping conditions. Examples of such heat stable salts are those salts that are formed from strong acids such as sulfuric acid, nitric acid, or hydrochloric acid. If allowed to accumulate, these heat stable salts would eventually completely neutralize the sulfur dioxide absorption capacity of the amine absorbent. Accordingly, processes have been developed to remove heat stable salts from absorbents. (See for example United States Published Application 2010/0144908).

In some processes, diamine absorbents are used. Diamine absorbents have two different amines, each of which has a different pKa. Typically, one of the amines has a higher pKa. This stronger amine will result in the production of heat stable salts. Accordingly, the stronger amine (the one with the higher pKa) is typically reacted with a strong acid (e.g. sulfuric acid) so as to convert the amine to a salt. Accordingly, the lean amine absorbent, which is exposed to the acid gas, is typically in its half-salt form. Accordingly, only the weaker, more moderate amine is available for reacting with the acid gas and releaseably absorbing the acid gas.

If the stronger amine is not half salted when first exposed to the acid gas (i.e. there is no sulfate to salt it), the pH of the amine absorbent will be very high (e.g., a pH of 10-11). The absorbent will be very efficient for absorption of SO₂; however, at these pH levels, the SO₂ will be mainly in the sulfite form (SO₃²⁻) and therefore very difficult to be stripped out of the solution during the regeneration step.

If the absorbent is to be regenerated by steam stripping, the absorbent is selected so that the salt formed by the acid gas with the amine absorbent is of a moderate strength so that the absorbent is regenerable under steam stripping conditions. For example, it has been suggested that a diamine absorbent has an amine with a pKa in the range of 4.5-6.7 (see U.S. Pat. No. 5,019,361 Hakka). As the stronger amine is hindered by the strong acid (e.g. sulfur dioxide), only the weaker amine is available for reacting with and for releasing sulfur dioxide.

The efficiency of the process can be rated based upon the delta loading of the absorbent (namely, the amount of sulfur dioxide gas which is releaseably absorbed per unit of spent absorbent less the amount of sulfur dioxide gas which is releaseably absorbed per unit of regenerated absorbent). The higher the delta loading, the greater the amount of sulfur dioxide that is removed from an acid gas per cycle (absorption/stripping) of the regenerable absorbent.

### SUMMARY

In accordance with one aspect of this invention, an amine absorbent that has an increased delta loading is provided. For example, while a diamine absorbent that is half salted by a strong acid may have a delta loading of up to 106 gSO₂/L absorbent, the absorbent provided herein may have a delta loading from 165 gSO₂/L absorbent to 215 gSO₂/L absorbent and preferably from 180 gSO₂/L absorbent to 215 gSO₂/L absorbent. Accordingly, the absorbent disclosed herein may remove up to 2 times more acid gas per unit of absorbent per cycle.

In accordance with this aspect, one of the two amine functionalities of a diamine absorbent is salted with an organic acid. The organic acid has a pKa that is suitable for sulfur dioxide scrubbing. The use of the weak organic acid permits an increase in the delta loading which can be obtained thereby increasing the amount of sulfur dioxide that may be stripped from an acid gas for a detour of absorbent.

Without being limited by theory, it is believed that the organic acid provides a buffering effect. At the beginning of the absorption cycle, (e.g., regenerated absorbent may be introduced at the top of an absorption column), the pH of the absorbent is typically in the range of 5-6. As the absorbent is exposed to the acid gas (e.g., the absorbent may flow downwardly in counter-current flow to the acid gas), sulfur dioxide is absorbed into the absorbent and the pH of the absorbent is reduced. For example, the pH of the spent absorbent (e.g., the absorbent once it reaches the bottom of a counter flow absorption column) may be about 4. As the pH decreases, the weak acid converts from its basic form to its acidic form. For example, the organic acid may be formic acid. When the formic acid is in its basic form (formate), it forms a half-salt with the stronger diamine functionality. As the pH of the absorbent decreases, formate will convert to formic acid. This conversion frees up the stronger amine functionality to absorb additional sulfur dioxide. However, since the sulfur dioxide will enter the absorbent as sulfite and not sulfate, then this sulfur dioxide forms a salt with the stronger amine functionality that may be regenerably removed in a steam stripping process, thereby increasing the delta loading. Accordingly, an advantage of using an organic acid instead of nothing or a strong acid is that the organic acid buffers the absorbent in a pH range suitable for SO₂ absorption and regeneration.

Accordingly, when the lean sulfur dioxide absorbent is initially contacted with the sulfur dioxide containing gas, the stronger amine functionality of the diamine has been converted to its half-salt form due to the presence of the organic acid in its basic form. As the pH of the absorbing medium decreases, the pKa of the organic acid will result in the organic acid converting to its acidic form allowing at least some of the sulfur dioxide to form a salt with the stronger amine functionality. As a result, both of the amine functionalities may be utilized to absorb sulfur dioxide thereby increasing the delta loading that may be achieved.

In prior art processes, the diamine has been half salted using a strong acid such as sulfuric acid. The use of sulfuric acid results in the stronger amine functionality forming a heat stable salt. The stronger amine functionality is accordingly not available to absorb any of the sulfur dioxide. Further, the presence of sulfate in the absorbent can result in the formation of additional heat stable salts, which must be periodically removed from the absorbent medium.

In accordance with an aspect of the present invention, there is provided a cyclic process for the removal of sulfur dioxide from a sulfur dioxide containing gas stream using an amine absorbent medium and for the regeneration of the absorbent medium comprising:
(a) contacting the gas stream with a lean aqueous absorbing medium to absorb sulfur dioxide from the gas and to form a sulfur dioxide lean treated gas stream and spent absorbing medium, the lean aqueous absorbing medium comprising a sulfur dioxide diamine absorbent and an organic acid, the organic acid selected to convert the sulfur dioxide diamine absorbent to its half salt form;
(b) steam stripping gaseous sulfur dioxide from the spent absorbing medium at a temperature to form a regenerated aqueous absorbing medium;
(c) recovering the gaseous sulfur dioxide; and,
(d) recycling the regenerated aqueous absorbing medium to the contacting step.

The lean aqueous absorbing medium may have a pH from 4.5 to 6.5 and preferably from 5 to 6.5.

The organic acid may have a pKa from 2.5 to 6 and preferably from 3.5 to 5.5. The pKa may be selected so that reaction kinetics will cause the acid to convert from is basic form to its acidic form during the absorption stage of the cycle (e.g., during the passage of the absorbent through an absorption column).

The organic acid may have a pKa such that, at the pH of the lean aqueous absorbing medium, the organic acid is substantially (e.g., at least 75%, more preferably at least 85% and most preferably at least 90%) in its basic form and at the pH of the spent absorbing medium, the organic acid is substantially in its acidic form (e.g., at least 30%, more preferably at least 50).

The organic acid may comprise formic acid, glycolic acid, malonic acid, propanoic acid, succinic acid, phthalic acid, citric acid, adipic acid, tartaric acid, malic acid and mixtures thereof and preferably the organic acid may comprise formic acid, malonic acid, malic acid, tartaric acid, citric acid, adipic acid and mixtures thereof.

The diamine may have an amine with a lower pKa and an amine with a higher pKa and the higher pKa is above 6.5. Preferably, the higher pKa is above 7.5. Optionally, or in addition, the lower pKa may be less than 5.0 and preferably less than 4.0.

The diamine may comprise hydroxyethyl piperazine, bis-hydroxyethyl piperazine, piperazine, Hydroxyethylethylenediamine, bis-hydroxyethylethylenediamine and mixtures thereof and, preferably, the diamine comprises bis-hydroxyethyl piperazine.

The diamine may have an amine with a lower pKa and an amine with a higher pKa and the aqueous absorbing medium has an organic acid concentration to neutralize the amine with a higher pKa prior to the lean aqueous absorbing medium contacting the sulfur dioxide containing gas.

The lean aqueous absorbing medium may have a heat stable salt concentration prior to contacting the sulfur dioxide containing gas that is less than 0.5 equivalents of acid per mole of diamine. Preferably, the lean heat stable salt concentration prior to contacting the sulfur dioxide containing gas is less than 0.1 equivalents of acid per mole of diamine.

### DRAWINGS

These and other advantages will be understood in accordance with the following description of a preferred embodiment in which:

FIG. 1 is a simplified flow sheet of a cyclic process according to one embodiment of the invention; and,

FIG. 2 sets out the lean loading, delta loading (defined as rich loading-lean loading), the pH of the lean SO₂ solution, and the pKa of the organic acid used in the mixture with the amine.

### DESCRIPTION OF VARIOUS EMBODIMENTS

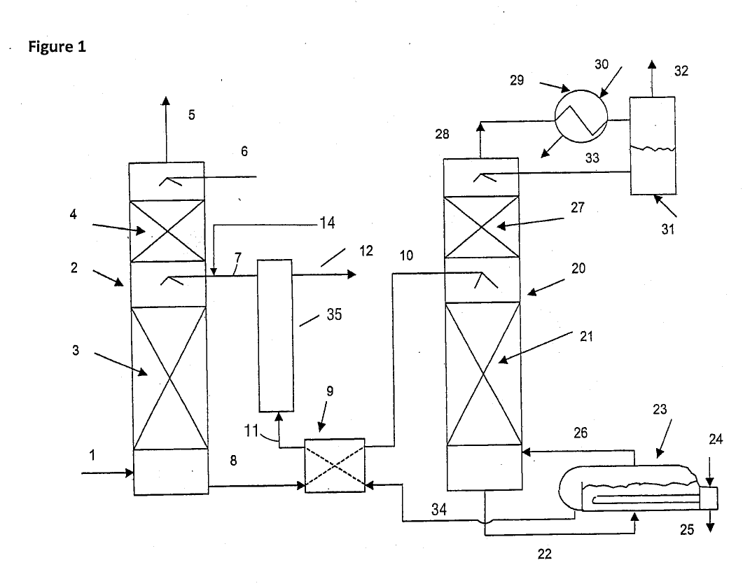

A process flow diagram for an exemplary embodiment of a process to capture SO₂ is shown in FIG. 1. FIG. 1 exemplifies a heat rengenerable absorbent cycle. The absorbent is exposed to an acid gas whereby SO₂ is absorbed into the absorbent and removed from the feed gas stream 1. The absorbent is then regenerated by heat, such as in a steam-stripping column 20. The regenerated absorbent may then be cycled back to absorb more SO₂.

Referring to FIG. 1, a SO₂ containing feed gas stream 1 is treated to obtain a SO₂ rich absorbent stream 8 (the spent absorbent stream). The feed gas stream 1 may be any stream, which contains SO₂ at levels, e.g., suitable for treatment for SO₂ removal before the gas is released to the atmosphere, such as flue gas from a fluid catalytic cracker unit, an acid plant tail gas a coal fired power plant off-gas or the like.

SO₂ rich absorbent stream 8 is prepared by contacting feed gas stream 1 with any of the SO₂ absorbents taught herein. The absorbent may be contacted with feed gas stream 1 using any means known in the art. As exemplified in FIG. 1, feed gas stream 1 flows into a gas-liquid contact apparatus 2, where intimate contact between feed gas stream 1 and lean absorbent stream 7 occurs. Apparatus 2 may be any gas-liquid contactor or absorption tower known in the art, such as a spray or packed tower. Illustrative contacting devices include countercurrent absorption columns including packed columns and tray columns, countercurrent or co-current spray columns including Waterloo scrubbers, venturi scrubbers; thin film contactors and semipermeable membranes. FIG. 1 illustrates a counter current flow packed tower, wherein liquid gas contact is promoted by suitable random or structured packing 3 in the column. SO₂ is absorbed into the lean absorbent stream 7, producing rich SO₂ containing absorbent, which exits from the apparatus 2 as SO₂ rich absorbent stream 8.

The amount of absorbing medium employed per unit volume of gas and the contact time may be sufficient to effect removal of substantially all the SO₂ from the gas stream, or to leave a desired residual amount, e.g., less than 500 ppmv, preferably less than 200 ppmv, even less than 100 ppmv, SO₂. The process is applicable to any SO₂ containing gas stream, e.g., up to 20 or 50 volume percent SO₂, but is particularly useful for application to flue gas streams from thermal generating plants, which contain about 700 to about 5000 ppmv SO₂, typically about 1000 to 3000 ppmv SO₂.

In a preferred embodiment, feed gas stream 1 is at least about at 90 percent saturation with water to prevent undue dehydration of the absorbing medium, although in some cases a relatively water-unsaturated gas may be contacted with the amine absorbing medium in order to save capital investment or minimize the space required. Advantageously, the gas is relatively free from particulates such as fly ash to minimize fouling of the gas-liquid contact equipment or providing materials that might catalyze the disproportionation reaction or the oxidation of sulphite or bisulphite.

The contact of the absorbing medium with the SO₂ containing gas stream is preferably effected within the temperature range from the freezing point of the absorbent up to about 75° C., preferably about 10° C. to about 60° C., more preferably about 10° C. to about 50° C., and is preferably effected to obtain a loading of SO₂ of at least 50 grams of sulfur dioxide per kilogram of absorbing medium, preferably about 150 to about 300.

The pH of the lean absorbent at the point of contact with feed gas stream 1 is preferably in the range of about 4.5-6.5, more preferably 5 to 6.5 and most preferably 5 to 6. The pH of the absorbent at the end of the contacting stage (e.g., at the bottom of the absorption column) is preferably in the range of about 3-5 and more preferably 4 to 5.

Accordingly, the pH of the absorbing medium during the absorption process may vary from about 6.5-3.0, more preferably about 6.5-3.5 and most preferably about 6.0-4.0. Usually the lean absorbing medium (lean absorbent stream 7) initially has a pH close to the upper end of this range, while the pH of the SO₂ rich amine absorbent (SO₂ rich absorbent stream 8) is on the lower end and may be determined by the absorption conditions, particularly the partial pressure of SO₂ in the feed gas and the absorption temperature. Thus, as SO₂ is absorbed and the solution tends to become more acidic, the pH moves towards the lower end of the range.

In order to enhance the removal of sulfur dioxide and facilitate stripping and regeneration of the amine absorbent, a low temperature for the absorption, which enables significant absorption of SO₂, is preferred. As the absorption temperature is increased, the amount of SO₂ absorbed per mole equivalent of sorbing nitrogen is decreased. Advantageously, the sorbing amine used in the processes of this invention, given their pKa values of between, e.g., 3.0 and 5.5, are relatively weak bases and hence can be regenerated with less energy consumption and at a lower temperature than are stronger bases.

The time of contact between the gas and absorbing liquid will depend upon the intimacy of contact between the phases and the rate of transfer of the SO₂ into the liquid phase. For spray-type scrubbers, the contact time may be less than 1 or 2 seconds. With absorption columns, the contact time may be 30 seconds or more. The pressure may vary widely, e.g., from sub-atmospheric to super-atmospheric pressures. Since higher pressures increase the partial pressure of a given concentration of SO₂, they are favored from a thermodynamic standpoint. However, in many instances the gas to be treated is at a pressure slightly higher or lower than the ambient pressure and raising the pressure is economically undesirable.

The feed gas stream 1, which is reduced in SO₂, may be optionally washed with water (stream 6), such as in another packed section 4, to remove absorbent that may have splashed or volatilized into the treated gas stream traveling upwardly through apparatus 2. The gas then leaves the apparatus 2 as treated feed gas stream 5 for, e.g., release into the atmosphere or for further treatment or use.

The water of stream 6 may be a part of condensate stream 33 or it may be makeup water introduced to the process. The water balance in the overall process may be maintained by adding water, for example via stream 6, or withdrawing water from the process, such as by directing a part of stream 33 to waste.

In order to conserve energy, heated streams may be used to preheat cooler streams that are subsequently fed to the process equipment. For example, as exemplified in FIG. 1, SO₂ rich absorbent stream 8 flows through an indirect cross flow heat exchanger 9, where it is indirectly heated by stream 34 (a heated lean amine stream which is recycled to absorb SO₂), and is then introduced into regeneration tower 20 as stream 10.

Heated SO₂ rich absorbent stream 10 is then treated at a temperature, preferably higher than the absorption temperature in apparatus 2, to regenerate the absorbent. The absorbent may be heated by any means known in the art. Preferably, the absorbent is reheated by means of steam. In such a case, regeneration tower 20 may be a steam-stripping tower. However, other sources of heat such as hot gas, heat transfer liquids and direct firing may be used. As exemplified in FIG. 1, SO₂ in downwardly moving heated SO₂ rich absorbent stream 10 is removed by upwardly moving stripping gas or steam to produce a SO₂ rich product stream 28 and a regenerated absorbent (heated lean absorbent stream 22). Inert gas stripping may also be practiced for stripping the SO₂ from heated SO₂ rich absorbent stream 10 in tower 20.

Regeneration tower 20 may be of either a packed or trayed design. A packed tower with a packing section 21 is shown in FIG. 1 below the SO₂ rich absorbent feed level (stream 10). The SO₂ rich absorbent is stripped of SO₂ as it flows downward in the tower and into optional reboiler 23. Reboiler 23 is heated by any means known in the art. Preferably reboiler 23 is indirectly heated by stream 24 (which may be steam and may be obtained from any source) through, e.g., a heat transfer tube bundle, producing a steam condensate stream 25 which may be recycled to produce additional steam or used elsewhere in the plant. The boiling of an aqueous liquid (e.g., SO₂ lean absorbent) in reboiler 23 produces a flow of steam 26 into the regeneration tower 20. The steam ascends through the tower, heating the downward flowing SO₂ absorbent and carrying upwards the SO₂ evolved from the SO₂ absorbent. The steam and SO₂ mixture exits the tower as product stream 28.

The desorption (regeneration) process may be conducted under any temperature and pressure conditions known in the art. It is generally desirable to maintain a differential in temperature between the absorption and desorption steps of at least about 30° C., and the desorption temperature may be less than about 110° C., e.g., about 50° C. to about 110° C., to provide a driving force for the desorption.

Desorption is preferably effected by gaseous stripping using steam generated in situ or by passing an inert gas through the spent absorbing medium, usually at near atmospheric pressure. Lower pressures somewhat favor desorption. The amount of stripping gas may vary from 0 to about 100 liters per liter of absorbing medium. During stripping, the amine salt of the sorbing nitrogen is returned to its basic form while SO₂, thought to be present mainly as sulfite and bisulphite ions in the spent absorbing medium, is released from the aqueous medium as gaseous SO₂.

The delta loading ratio of SO₂ is preferably about 165 gSO₂/L absorbent to 215 gSO₂/L absorbent and more preferably 180 gSO₂/L absorbent to 215 gSO₂/L absorbent During stripping, the pH of the solution usually rises as the acidic SO₂ is removed. The conditions maintained during the stripping operation may be selected to achieve the desired level of regeneration of the absorbent (e.g. the level of dissolved SO₂ left in the absorbent).

Preferably, product stream 28 is treated to remove excess water vapor contained therein. Preferably, the water vapor is removed by condensation (e.g. by cooling with a cooling liquid). As shown in FIG. 1, a flow of cooling water 30 into overhead condenser 29 causes condensation of steam in product stream 28, producing a 2-phase mixture, which flows into the condensate accumulator 31. The gaseous phase, which is water saturated SO₂ leaves as product stream 32. Some or all of the condensed water may be returned to the regeneration tower 20 as stream 33, where it flows downward through optional packed section 27. The cool condensate of stream 33 serves to wash volatilized absorbent from the vapors before they leave the tower 20 as product stream 28. This may help to reduce loss of absorbent chemical with the gaseous SO₂ stream 32. It will be appreciated that additional treatment steps may be used to further limit the loss of absorbent from the process.

Preferably, hot lean absorbent stream 34 is used to preheat SO₂ rich absorbent stream 8. However, it will be appreciated that stream 8 may be heated by other means (e.g., by passing it through reboiler 23 or heating stream 8 upon entry to tower 20 or any combination thereof. As shown in FIG. 1, SO₂ lean amine leaves regeneration tower 20 as stream 22 and enters the reboiler 23. The SO₂ lean absorbent may then leave the reboiler 23 by, e.g., overflowing a weir as heated lean adsorbent stream 34, which passes through the cross flow heat exchanger 9 to preheat stream 8. The SO₂ lean absorbent leaves heat exchanger 9 as cooler lean absorbent stream 11, which may optionally be cooled further by a lean solvent trim cooler 35.

Optionally, the SO₂ absorbent may be treated to remove heat stable salt (HSS) that may build up therein. As exemplified in FIG. 1, a slipstream 12 may be drawn from lean solvent trim cooler 35 and sent to a HSS removal unit and stream 14, which comprises SO₂ absorbent reduced in HSS, joins the recycled cooled lean absorbent to form stream 7 (the SO₂ lean absorbent stream which is introduced into tower 2). HSS removal may be effected by any method known in the art, such as electrodialysis or ion exchange. The stream 7 enters the absorption tower 2 for capturing SO₂ from the feed gas stream 1.

The process may be operated with any convenient pressure in the absorber 2. If the feed gas stream 1 is flue gas from a boiler, which usually is operated near atmospheric pressure, then tower 2 may be operated at about atmospheric pressure or a bit below the pressure of feed gas stream 1 so as to favor the flow of feed gas stream 1 into tower 2. The regeneration tower 20 is often operated at a pressure slightly over atmospheric, generally not exceeding 3 bar absolute. An above-atmospheric pressure in the regenerator helps to strip as much SO₂ as possible, due to the higher temperatures that can be achieved. Furthermore, the product SO₂ will be at a higher pressure, helping it to flow to a downstream unit without the aid of a fan or compressor.

The diamine absorbent may be any diamine absorbent known the regenerable sulfur dioxide absorbent art. The diamine absorbent may be represented by the structural formula:

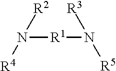

wherein R¹ is an alkylene of two or three carbon atoms, R², R³, R⁴, and R⁵ may be the same or different and can be hydrogen, alkyl (e.g., lower alkyl of 1 to about 8 carbon atoms including cycloalkyls), hydroxyalkyl (e.g., lower hydroxy alkyl of 2 to about 8 carbon atoms), aralkyl (e.g., 7 to about 20 carbon atoms), aryl (often monocyclic or bicyclic), alkaryl (e.g., 7 to about 20 carbon atoms), and any of R², R³, R⁴, and R⁵ may form cyclic structures.

The diamines preferably are tertiary diamines, in view of their stability. However, other diamines in which one or both of the nitrogen atoms is primary or secondary and which otherwise meet the parameters discussed below may be employed, provided mild oxidative or thermal conditions exist to minimize chemical reaction of the solvent. Often, the preferred amine salt absorbents have a hydroxyalkyl group as a substituent on an amine group. In some instances, the hydroxy substituent is believed to retard the oxidation of sulphite or bisulphite to sulfate.

It is preferable for the free amine form of the amine salt absorbent to have a molecular weight less than about 300, preferably less than about 250.

The tertiary diamine may be of the formula:

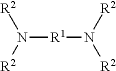

wherein R¹ is an alkylene group, preferably containing from 2 to 3 carbon atoms as a straight chain or as a branched chain, and each R² is the same or different and is an alkyl group, preferably methyl or ethyl, or a hydroxy-alkyl group, preferably 2-hydroxyethyl. Specifically preferred compounds are N,N¹N¹-(trimethyl)-N-(2-hydroxyethyl)-ethylenediamine (pKa=5.7); N,N,N¹, N¹-tetrakis(2-hydroxyethyl)ethylenediamine (pKa=4.9); N,N′-dimethylpiperazine (pKa=4.8); N,N,N¹,N¹-tetrakis(2-hydroxyethyl)-1,3-diaminopropane; N¹,N¹-dimethyl-N,N-bis(2-hydroxyethyl)ethylenediamine; N-(2hydroxyethyl)piperazine and N,N¹-di(2-hydroxyethyl)piperazine used either individually or in combination. Also included among the useful diamines are heterocyclic compounds, such as piperazine (pKa=5.8) and 1,4-diazabicyclo[2.2.2]octane (pKₐ=3.2). The pKa values are for the weaker, sorbing nitrogen.

The diamine may be selected from the group comprising hydroxyethyl piperazine, bis-hydroxyethyl piperazine, piperazine, Hydroxyethylethylenediamine, bis-hydroxyethylethylenediamine and mixtures thereof. Most preferably, the diamine comprises bis-hydroxyethyl piperazine.

Preferably, the diamine has an amine with the lower pKa and an amine with the higher pKa wherein the higher pKa is above 6.5 and, preferably, above 7.5. The lower pKa is preferably less than 5.0 and more preferably less than 4.0.

It will be appreciated that, in some embodiments, one or diamines may be used as the absorbent and one or more diamines may be used with other heat regenerable sulfur dioxide absorbents.

The absorbing medium preferably contains at least one mole of water and usually more for each mole of SO₂ to be removed from the gas stream. The water acts both as a solvent for the amine salt and as for a reactant to produce “sulfurous acid” H₂SO₃ from the SO₂. The proportion of water present may be up to about 80 weight percent of the absorbing medium and preferably about 25 to about 75 weight percent of the absorbing medium.

The amount of amine absorbent is preferably in an amount sufficient to provide a spent absorbing medium containing at least about 180 grams of sulfur dioxide per kilogram of absorbing medium. The amount of amine absorbent, however, is preferably not so great as to either (a) unduly increase the viscosity of the absorbing medium such that undesirable pressure drops are incurred in the gas stream passing through an absorber vessel or (b) render the absorbing medium difficult to atomize, in e.g., a Waterloo scrubber. Preferably, the viscosity of the absorbing medium is below about 1200 centipoise at 25° C., e.g., between about 1 and 500 centipoise at 25° C.

It is not essential that the amine salt absorbent and water be miscible under any of the conditions of the process, nor is it essential that the amine salt absorbent be liquid under all the conditions of the process. Frequently, the solubility of the amine salt absorbent in water is at least about 0.01, often at least about 0.1, mole per liter at 25° C. Preferably, the amine salt absorbent is miscible with water under the conditions in the process.

The organic acid preferably has a pKa such that, at the pH of the lean aqueous absorbent the organic acid is substantially in its basic form and, at the pH of the spent absorbent, the organic acid is substantially in its acidic form. For example, if the organic acid is formic acid, then at the pH of lean absorbent stream 7, the formic acid is present as formate and, at the pH of the spent absorbing medium (SO₂ rich absorbent stream 8), the organic acid is substantially in the form of formic acid. By substantially, it is meant that at least 30%, more preferably at least _{—}50%, of the organic acid is in particular form at the specified pH.

The organic acid may have a pKa of 2.5-6 and preferably, 3.5-5.5.

The organic acid may comprise one or more of formic acid, glycolic acid, malonic acid, propanoic acid, succinic acid, phthalic acid, citric acid, adipic acid, tartaric acid, malic acid and mixtures thereof.

More preferably, the organic acid comprises one or more of formic acid, malonic acid, malic acid, tartaric acid, citric acid, adipic acid and mixtures thereof.

### Example

Several aqueous amine and weak organic acid mixtures were charged in a cell at a temperature of 50° C. A gaseous mixture of air and 8% SO₂ was bubbled in each solution, until the vapour-liquid equilibrium was reached, thereby producing a rich SO₂ solution. The SO₂ loading of the rich SO₂ solutions was then measured by ion chromatography.

Each rich SO₂ solution was then regenerated at 90° C. by sparging N₂ into the cell, until the vapour-liquid equilibrium was reached, thereby producing a lean SO₂ solution. The SO₂ loading of the lean SO₂ solutions was then measured by ion chromatography. The pH of the lean SO₂ solutions was also measured.

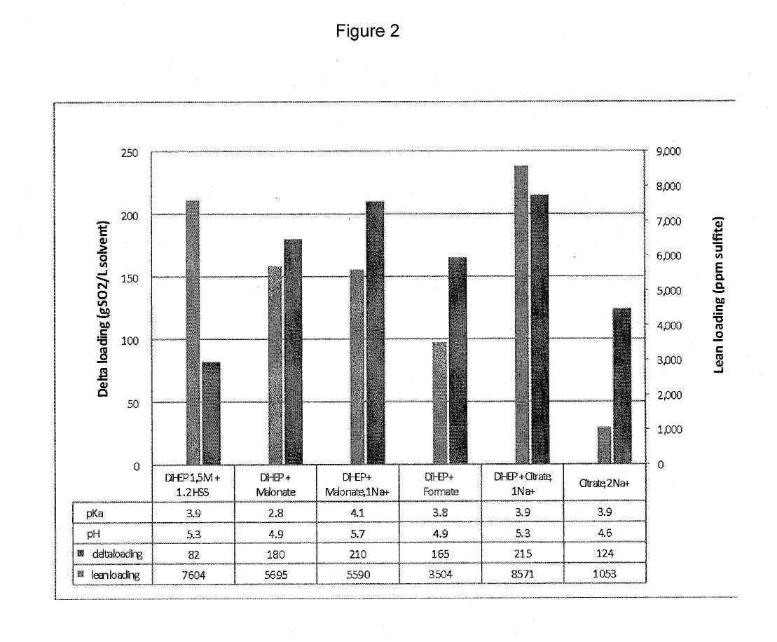

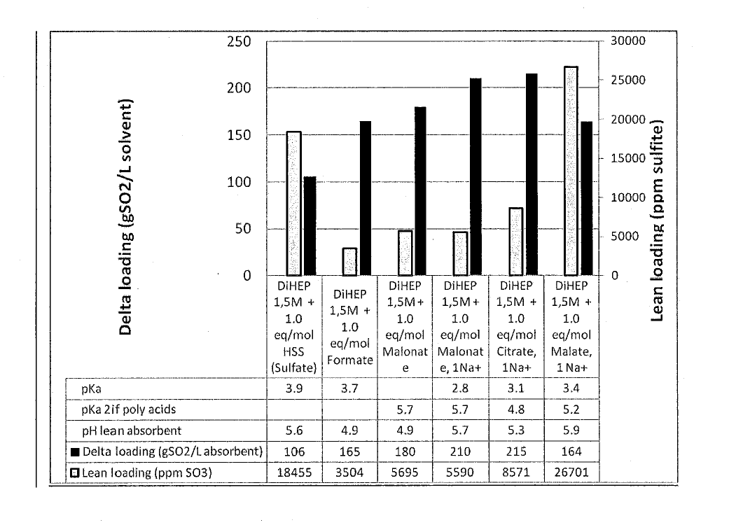

FIG. 2 sets out the lean loading, delta loading (defined as rich loading-lean loading), the pH of the lean SO₂ solution, and the pKa of the organic acid used in the mixture with the amine.

As shown if FIG. 2, when bis-hydroxyethylpiperazine (Di-HEP) is half salted by a weak organic acid, the delta loading varies from about 160-210 g SO₂/L solvent. However, when Di-HEP is half salted by strong acid such as sulfate, the delta loading is about 106 g SO₂/L solvent. Therefore, when Di-HEP is half salted by a weak organic acid, the delta loading is doubled the delta loading that is obtained when Di-HEP is half salted by a strong acid such as sulfate. The bigger the delta loading, the higher amount of SO₂ that can be absorbed in the same volume of amine solvent, and therefore less amine solvent needs to be circulated to remove the same amount of SO₂ from a gas stream.

Furthermore, there was a significant reduction in the lean loading that was obtained using DiHEP and a weak organic acid mixture compared to DiHEP and SO₄. The lower the lean loading attained under the same regeneration conditions (in this example, under N₂ sparging at 90° C.), the lowest lower the energy required for the regeneration of the system under a commercial application. Accordingly, the use of a suitable diamine with a weak organic acid can produce a regenerated lean amine absorbent having a lower lean loading without any additional energy input during the regeneration stage of the cycle.

1. A cyclic process for the removal of sulfur dioxide from a sulfur dioxide containing gas stream using an amine absorbent medium and for the regeneration of the absorbent medium comprising:
a) contacting the gas stream with a lean aqueous absorbing medium to absorb sulfur dioxide from the gas and to form a sulfur dioxide lean treated gas stream and spent absorbing medium, the lean aqueous absorbing medium comprising a sulfur dioxide diamine absorbent and an organic acid, the organic acid selected to convert the sulfur dioxide diamine absorbent to its half salt form;
b) steam stripping gaseous sulfur dioxide from the spent absorbing medium at a temperature to form a regenerated aqueous absorbing medium;
c) recovering the gaseous sulfur dioxide; and,
d) recycling the regenerated aqueous absorbing medium to the contacting step.

2. The process as claimed in claim 1 wherein the lean aqueous absorbing medium has a pH of 4.5 to 6.5.

3. The process as claimed in claim 1 wherein the lean aqueous absorbing medium has a pH of 5 to 6.

4. The process as claimed in claim 1 wherein the organic acid has a pKa of 2.5 to 6.

5. The process as claimed in claim 1 wherein the organic acid has a pKa of 2.5 to 5.5.

6. The process as claimed in claim 1 wherein the organic acid has a pKa such that, at the pH of the lean aqueous absorbing medium, the organic acid is substantially in its basic form and at the pH of the spent absorbing medium, the organic acid is substantially in its acidic form.

7. The process as claimed in claim 1 wherein the organic acid comprises formic acid, glycolic acid, malonic acid, propanoic acid, succinic acid, phthalic acid, citric acid, adipic acid, tartaric acid, malic acid and mixtures thereof.

8. The process as claimed in claim 1 wherein the organic acid comprises formic acid, malonic acid, malic acid, tartaric acid, citric acid, adipic acid and mixtures thereof.

9. The process as claimed in claim 1 wherein the diamine has an amine with a lower pKa and an amine with a higher pKa and the higher pKa is above 6.5.

10. The process as claimed in claim 9 wherein the higher pKa is above 7.5.

11. The process as claimed in claim 1 wherein the diamine has an amine with a lower pKa and an amine with a higher pKa and the lower pKa is less than 5.0.

12. The process as claimed in claim 11 wherein the lower pKa is less than 4.0.

13. The process as claimed in claim 1 wherein the diamine comprises hydroxyethyl piperazine, bis-hydroxyethyl piperazine, piperazine, Hydroxyethylethylenediamine, bis-hydroxyethylethylenediamine and mixtures thereof.

14. The process as claimed in claim 1 wherein the diamine comprises bis-hydroxyethyl piperazine.

15. The process as claimed in claim 1 wherein the diamine has an amine with a lower pKa and an amine with a higher pKa and the aqueous absorbing medium has an organic acid concentration to neutralize the amine with a higher pKa prior to the lean aqueous absorbing medium contacting the sulfur dioxide containing gas.

16. The process as claimed in claim 1 wherein the lean aqueous absorbing medium has a heat stable salt concentration prior to contacting the sulfur dioxide containing gas that is less than 0.5 equivalents of acid per mole of diamine.

17. The process as claimed in claim 16 wherein the lean heat stable salt concentration prior to contacting the sulfur dioxide containing gas is less than 0.1 equivalents of acid per mole of diamine.
